(19) United States
(12) Patent Application Publication
(10) Pub. No.: US 2011/0249272 A1
(43) Pub. Date: Oct. 13, 2011

(54) OPTICAL INSTRUMENT FOR TESTING OPTICAL SYSTEMS AND SAMPLES

(75) Inventors: Maria Voznesenskaya, Tartu (EE); Aleksei Kuznetsov, Narva (EE); Jung Mee Suk, Gyeonggi-Do (KR); Heorhi Tsikhanchuk, Minsk (BY)

(73) Assignee: VTT-NTM OU, Tartu (EE)

(21) Appl. No.: 13/140,022

(22) PCT Filed: Nov. 30, 2009
(86) PCT No.: PCT/EP09/66065

§ 371 Date: Jun. 16, 2011

(30) Foreign Application Priority Data
Dec. 16, 2008 (EE) P200800069

(51) Int. Cl. G01B 9/02

(52) U.S. Cl. 356/521

(57) ABSTRACT

The present invention is related with the optical instrument such as interferometer for testing the optical systems and samples whereas the optical instrument comprises the laser (1) for generating the laser beam which passes the beam expander (2), beam-splitter (23) dividing the laser beam to a working light beam and reference light beam, focusing objectives (3, 7), flat glass plate (4) with one side coated by thin metal highly reflecting coating with the pattern including a pinhole, computer (12), CCD camera (13), tested part or optical system (6). In addition the optical instrument comprises at least two flat mirrors (24, 25), observation objective and at least one stop (20) placed between the beam-splitter (23), flat mirrors (24, 25) and/or focusing objective (7).

### TECHNICAL FIELD

The present invention concerns the area of optical instrument making and can be used for testing optical systems and samples, including those having a high level of accuracy of correction of aberrations and errors, with deformations of wave front less than 1/90 wavelength, in particular the present invention is related with the interferometer for testing the optical systems and samples.

### BACKGROUND ART

The closest prior art is the interferometer described in the document KR 20050102264 A (KOREA ELECTRO TECH RES INST) 26.10.2005. The named interferometer should be accepted as the prototype, intended for testing optical surfaces and optical systems.

The above-mentioned interferometer (see FIG. 1, prior art) comprises: laser 1; elements of an objective of the illuminating system 2, 3; inclined flat mirror 4, in whose reflection coating there is a pinhole aperture 5, whose diameter is comparable with the wavelength of radiation passing through the interferometer; tested optical element 6; autocollimating illuminating optical system 7 and 8 constructed as a collimator 7, whose focus coincides with the pinhole aperture of the flat mirror 5, and after an objective of a collimator 7, towards to it, the objective 8 of the second collimator is disposed, in whose focal plane an autocollimating flat mirror 9 is disposed; an autocollimating flat mirror is fixed on the holder as a piezo-element 10, to whose electrodes the control electronic block 17 is connected, the voltage from which provides reciprocating movement of a flat mirror along the optical axis; further there are established an objective 11, Bertran lens 12, projection objective of the observing system 13 for matching the scale of the interference picture. The eyepiece is replaced with the television matrix receiver of the image in the television camera 14, forming video signal corresponding to the light intensity distribution exposure in the fringe pattern. The recorder of the image is connected through the electronic block of fringe centers detection 15 to the TV-monitor, which may be a computer monitor 16 as well.

The prototype has the following disadvantages:
1. Instability of work of the autocollimating illuminating system and difficulties of its adjustment; difficulties are rather considerable because of necessity to fulfil simultaneously two contradicting conditions: keeping orthogonality of the flat mirror to the common axis of the two collimators and tilting this mirror in order to compensate lateral shift of the axis of the first collimator which is necessary to grasp the flare of the collimated beam reflecting from the flat mirror serving as a beam-splitter;
2. Using the flat mirror with the pinhole as a beam-splitter leads also to insufficient quality of the reference wavefront produced by the illuminating light beam; worsened quality comes from the following two reasons: a) poor energy of the main maximum of the working beam because of its fall into the pinhole leaving to the reflected part very few energy from the incident one, b) inevitable inhomogeneity of the reference wavefront amplitude because of its strong dependence on the quality of reflectance of the illuminating beam flare by the flat mirror with the pinhole.
3. Twice sensitivity in the autocollimating scheme of the fringe pattern quality, its homogeneity and illumination to possible smallest shifts of the mirror with the pinhole; this together with disadvantages 1) and 2) results in permanent scintillations of the fringe pattern while work of the interferometer.
4. Impossibility to use the interferometer under conditions of manufacture due to very strong sensitivity to vibrations and operational movements.
5. Cross-like schematic of the interferometer makes it difficult to place all the components of it into a compact arrangement.

The disadvantages of the prototype lead to that its desirable properties are not obtained, such as increase of:
Accuracy of measurements,
Reliability,
Productivity,
Efficiency of testing
Value of display of measurement results.

### DISCLOSURE OF INVENTION

The aim of the present invention is to overcome the above-mentioned disadvantages and to propose the improved interferometer. The improved construction of the interferometer according to present invention is obtained by that the following new elements are introduced into the device:
1. The autocollimating illuminating optical system is replaced by the independent reference light beam track constructed of two flat mirrors and the focusing objective, whose focus coincides with the pinhole aperture of the flat mirror.
2. The flat glass plate mirror with the pinhole does not work as a beam-splitter, whose role is given to a flat glass beam-splitter which splits the light beam going from the laser source into two beams: working light beam and reference light beam. The flat mirror with the pinhole works not as a two-beam splitter but a two-beam conjugator.
3. The Bertran lens with the projection objective of the observing system is replaced by the ZOOM system making it possible to magnify the fringe pattern without pixelazed distortion of the registered fringe pattern.
4. The cross-like scheme is replaced with the parallel light beam tracks which makes it possible compact arrangement of all the components of the instrument.

Instrument is disclosed for two point-diffracted wave-fronts which are freely emitted out of the instrument being split of each other under an angle and maintaining spatial coherence between them corresponding to the light source degree of spatial coherence, the instrument being based on the base plate which carries the coherent light source, beam expander and the tracks of two light beams namely working light beam and reference light beam, consisting of a beam-splitter in a tunable mount with an arbitrary reflection-transmission ratio, regulating stop, two mirrors in tunable mounts, two objectives in tunable mounts, and a flat glass plate having one surface coated by highly reflecting thin metal layer placed in the tunable mount so that its metal coated surface is turned to the side opposite to the incidence of the two beams providing conjunction of the two beams and simultaneously acting as a point-diffraction source of two free wave-fronts constructed as having a pattern including a pinhole aperture and disposed under an angle to the axes of the two light beams.

Instrument is disclosed for precise testing topography of optical surfaces and wavefronts of optical systems without necessity of a reference surface, reference part, or any other reference artificial base.

### BRIEF DESCRIPTION OF DRAWINGS

The present invention is described in details in the following description with references to the enclosed drawings where

FIG. 1 shows the prior art interferometer,

FIG. 2 shows the optical instrument (interferometer) according to the present invention working in the amplitude mode,

FIG. 3 shows the interferometer illustrated in the FIG. 2 with possibility for regulation of homogeneity of the reference light beam according to the present invention,

FIG. 4 shows the interferometer according to the present invention working in the phase-shift mode

FIG. 5 shows the interferometer according to the present invention with additional tunable flat mirror.

### BEST MODE FOR CARRYING OUT THE INVENTION

Following will be described the optical instrument—interferometer in details with references to the drawings where in the FIG. 2 is illustrated the interferometer according to the present invention working in the amplitude mode.

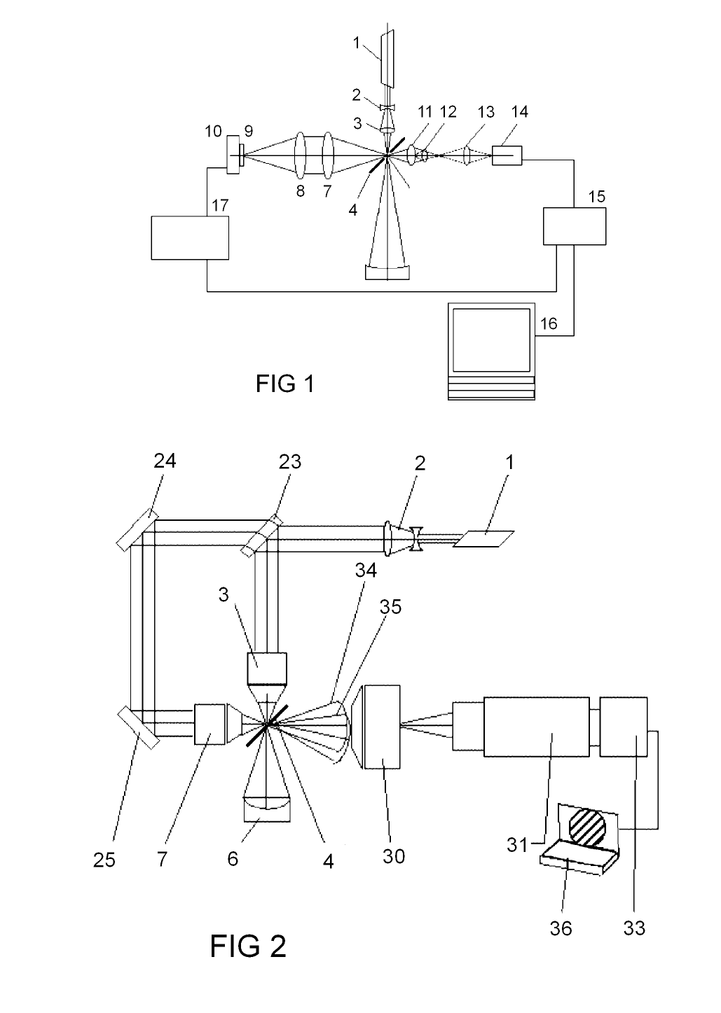

The details which are the same to the details of the prototype described above (see FIG. 1) have the same reference numbers.

The optical instrument (interferometer) comprises (see FIG. 2) the housing where are arranged: laser 1; beam expander 2, beam-splitter 23 in tunable mount; flat mirror 24, 25 in tunable mount; focusing objective 3, 7 in tunable mount; tested part or optical system 6; flat glass plate 4 with one side coated by thin metal highly reflecting coating with the pattern including a pinhole; observation objective 30; ZOOM system 31; computer 32; CCD camera 33. The interfering wavefronts 34, 35 will be originated to the objective 30.

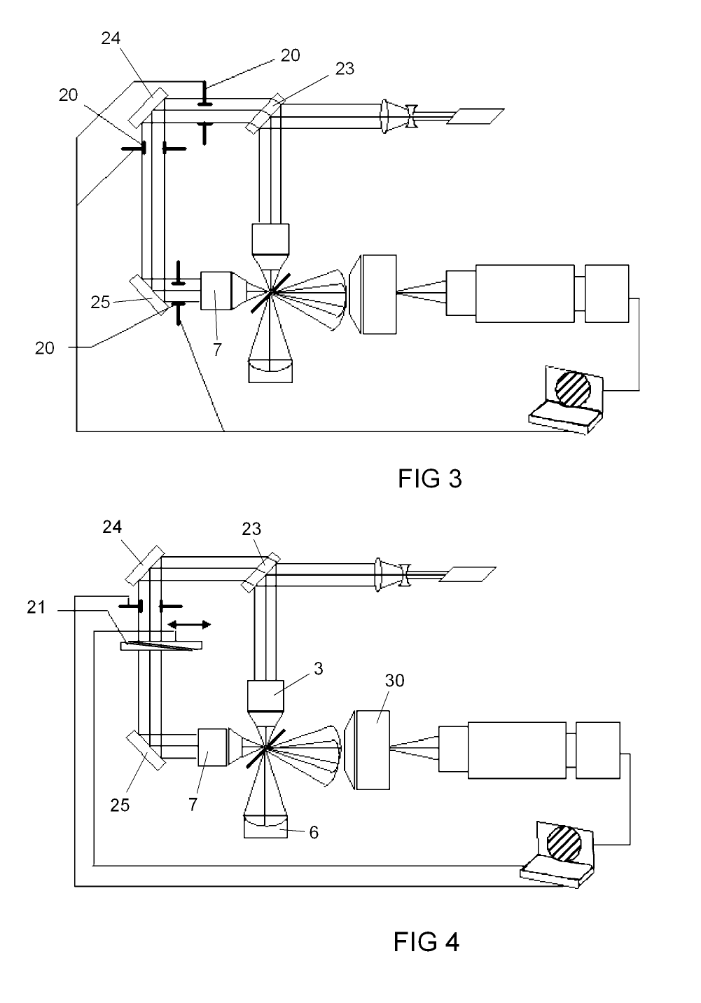

In another embodiment (see FIG. 3) of the present invention the interferometer contains in addition the stops placed in the reference light beam track regulating homogeneity and width of the reference light beam. The interferometer comprises in addition (other components are all the same ones of FIG. 2):
At least one stop 20 used for regulation of homogeneity of the reference light beam, this stop 20 can be placed in any part of the reference light beam track as given in the scheme.

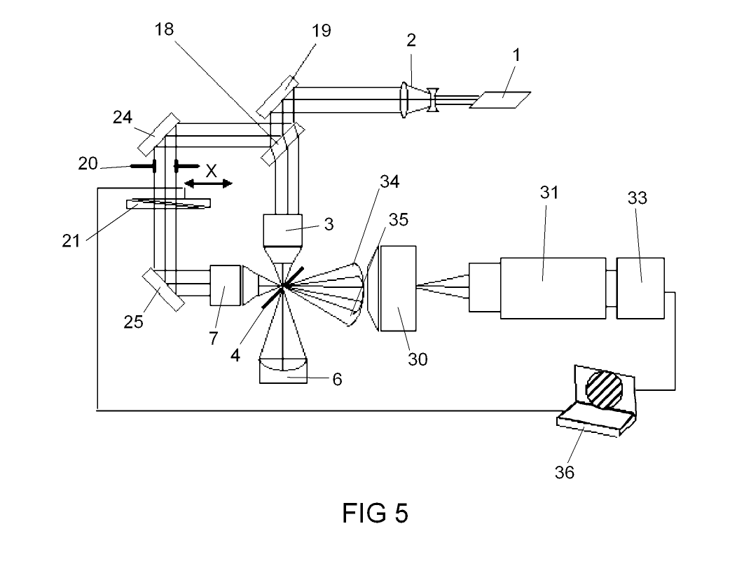

In the FIG. 4 is illustrated the interferometer according to the present invention working in the phase-shift mode whereas the interferometer comprises in addition (other components are all the same ones of FIG. 2 or FIG. 3):
two-wedge phase shifter 21 allowing careful change of the optical length of the reference light beam shown here optimally in construction but not limited to this placement being possibly placed between the beam splitter 23 and first flat mirror 24, or between second flat mirror 25 and focusing objective 7. The two-wedge phase shifter 21 is movable in the direction (see direction X in the FIG. 4) transverse to the reference light beam path.

In the FIG. 5 is illustrated the another embodiment of the interferometer illustrated in the FIG. 2-4 whereas there is added additional tunable flat mirror and clear flat glass plate working as a beam-splitter of the working and reference light beams.

The given interferometer comprises (other components are all the same ones of FIGS. 2, 3, 4) in addition:
uncovered flat glass plate 18 working as a beam-splitter optimally distributing light energy between the working and reference light beams; and
additional tunable flat mirror 19 is more convenient for tuning the working light beam instead of using for this purpose the beam splitter because its tuning mechanism can be placed only under the beam splitter whereas mechanism for tuning mirror 19 can be optimally attached to the not-working back side.

The instrument contains also observation objective 30, ZOOM optical system 31, CCD camera 33, and movement mechanisms for tuning all the components of the instrument with control of the computer 36 and respective computer program (software).

In order to increase the productivity, reliability and accuracy of measurements and value of estimations the optical instrument according to the invention has the following differences and principles of working.

The paths of the two light beams are constructed as two undependably adjustable parallel-beam tracks which are originated from the laser beam by a beam-splitter 23 and passing thereafter two flat mirrors 24, 25 and two focusing objectives 3, 7 whose focuses are put into coincidence with the pinhole aperture of the flat glass plate mirror 4.

The two undependably adjustable light beams have each their specific function in the instrument: the first light beam is a working light beam which passes from the beam-splitter 23 through the focusing objective 3 onto the pinhole aperture of the flat glass plate mirror 4; the second light beam is a reference light beam which passes from the beam-splitter 23, reflects from the first flat mirror 24, reflects from second flat the mirror 25, and passes through the focusing objective 7 onto the pinhole aperture of the flat glass plate minor 4.

The reference light beam initiates the reference point-diffracted wave-front 34 undependably on the working light beam, the reference wave-front 34 going to the observation objective 30 whose focus is put into coincidence with the pinhole aperture of the flat glass plate mirror 4.

The working light beam initiates the working point-diffracted wave-front 35 which goes to the tested optical surface or optical system 6 and after reflection on the tested surface or a special accessory of the tested optical system 6 returns back to the flat glass plate mirror 4 and is deflected by it to the observation objective 30 coming into interference with the reference wave-front 34.

The CCD camera 33 is attached to the ZOOM system 31 and is intended to register the signal in various scales, corresponding to the intensity distribution in the fringe pattern which is the result of interference of the working wave-front 35 and reference wave-front 34;

The CCD camera 33 is connected to the electronic analyzer e.g. computer 36, which serves as a work-station for collecting and transfer the information registered by the CCD camera and also for control of the ZOOM optical system and movement mechanisms for tuning all the components of the instrument.

In addition the movements of the stop 20, two-wedge phase shifter 21, flat mirrors 24, 25, beam-splitter 23, flat glass plate 18 and additional tunable flat mirror 19 are controlled by the computer 36 attached to the optical instrument and by the respective computer program running in the computer. Such control gives to the optical instrument the improvements which enable to adjust all optical details with the high precision.

The present invention is not limited with the embodiments described above and it is therefore to be understood to the person skilled in the art that within the scope of the added claims the invention may be practiced otherwise than as specifically described.

1. An optical instrument for testing optical systems and samples comprising:
a laser (1) proving a laser beam,
a beam expander (2),
focusing objectives (3, 7),
a flat glass plate (4) with one side coated by a thin metal highly reflecting coating with a pattern including a pinhole,
a computer (36) attached by an attachment to the optical instrument,
a CCD camera (13),
a tested part or optical system (6),
characterized by further comprising a beam-splitter (23) for splitting the laser beam to form a work light beam and a reference light beam, and at least two flat mirrors (24, 25), an observation objective (30) and a ZOOM system (31).

2. An optical instrument according to claim 1, further comprising at least one stop (20) placed between the beam-splitter (23) and the first flat mirror (24) whereby the stop (20) regulates homogeneity of the reference light beam.

3. An optical instrument according to claim 1 further comprising at least one stop (20) placed between the first flat mirror (24) and second flat mirror (25) whereby the stop (20) regulates homogeneity of the reference light beam.

4. An optical instrument according to claim 1 further comprising at least one stop (20) placed between the second flat mirror (25) and focusing objective (7) whereby the stop (20) regulates homogeneity of the reference light beam.

5. An optical instrument according to claim 1 further comprising at least one two-wedge phase shifter (21) placed between the first flat mirror (24) and second flat mirror (25) to allow a change to the optical length of the reference light beam whereby the two-wedge phase shifter (21) is movable in a direction (X) transverse to the reference light beam path.

6. An optical instrument according to claim 1 further comprising at least one two-wedge phase shifter (21) placed between the second flat mirror (25) and focusing objective (7) to allow to change the optical length of the reference light beam whereby the two-wedge phase shifter (21) is movable in a direction (X) transverse to the reference light beam path.

7. An optical instrument according to the claim 1 wherein the beam splitter (23) is formed by using a flat mirror (19) and a second flat glass plate (18) placed between the beam expander (2) and the first flat glass plate (4) whereby the second flat glass plate (18) is a beam-splitter which divides the laser beam to the reference light beam and to the working light beam.

8. An optical instrument according to claim 1 wherein information about intensity of a fringe pattern formed by the optical instrument is collected by the computer attachment to the optical instrument, whereas the computer (36) is provided to control the ZOOM system (31) and to control any tuneable components of the optical instrument.

9. An optical instrument according to claim 2 further comprising at least one stop (20) placed between the first flat mirror (24) and second flat mirror (25) whereby the stop (20) regulates homogeneity of the reference light beam.

10. An optical instrument according to claim 2 further comprising at least one stop (20) placed between the second flat mirror (25) and focusing objective (7) whereby the stop (20) regulates homogeneity of the reference light beam.

11. An optical instrument according to claim 3 further comprising at least one stop (20) placed between the second flat mirror (25) and focusing objective (7) whereby the stop (20) regulates homogeneity of the reference light beam.

12. An optical instrument according to claim 2 further comprising at least one two-wedge phase shifter (21) placed between the first flat mirror (24) and second flat mirror (25) to allow a change to the optical length of the reference light beam whereby the two-wedge phase shifter (21) is (X) transverse to the reference light beam path.

13. An optical instrument according to claim 3 further comprising at least one two-wedge phase shifter (21) placed between the first flat mirror (24) and second flat mirror (25) to allow a change to the optical length of the reference light beam whereby the two-wedge phase shifter (21) is movable in a direction (X) transverse to the reference light beam path.

14. An optical instrument according to claim 4 further comprising at least one two-wedge phase shifter (21) placed between the first flat mirror (24) and second flat mirror (25) to allow a change to the optical length of the reference light beam whereby the two-wedge phase shifter (21) is movable in a direction (X) transverse to the reference light beam path.

15. An optical instrument according to claim 2 further comprising at least one two-wedge phase shifter (21) placed between the second flat mirror (25) and focusing objective (7) to allow to change the optical length of the reference light beam whereby the two-wedge phase shifter (21) is movable in a direction (X) transverse to the reference light beam path.

16. An optical instrument according to claim 3 further comprising at least one two-wedge phase shifter (21) placed between the second flat mirror (25) and focusing objective (7) to allow to change the optical length of the reference light beam whereby the two-wedge phase shifter (21) is movable in a direction (X) transverse to the reference light beam path.

17. An optical instrument according to claim 4 further comprising at least one two-wedge phase shifter (21) placed between the second flat mirror (25) and focusing objective (7) to allow to change the optical length of the reference light beam whereby the two-wedge phase shifter (21) is movable in a direction (X) transverse to the reference light beam path.

18. An optical instrument according to claim 2 wherein information about intensity of a fringe pattern formed by the optical instrument is collected by the computer attachment to the optical instrument, whereas the computer (36) is provided to control the ZOOM system (31) and to control any tuneable components of the optical instrument.

19. An optical instrument according to claim 3 wherein information about intensity of a fringe pattern formed by the optical instrument is collected by the computer attachment to the optical instrument, whereas the computer (36) is provided to control the ZOOM system (31) and to control any tuneable components of the optical instrument.

20. An optical instrument according to claim 4 wherein information about intensity of a fringe pattern formed by the optical instrument is collected by the computer attachment to the optical instrument, whereas the computer (36) is provided to control the ZOOM system (31) and to control any tuneable components of the optical instrument.
